(19) United States
(12) Patent Application Publication
(10) Pub. No.: US 2004/0041347 A1
(43) Pub. Date: Mar. 4, 2004

(54) Permanently lubricated gasket

(76) Inventors: Jefferey Kurtis Beach, Norton, OH (US); Mark Knapp, Ravenna, OH (US)

Correspondence Address: WATTS, HOFFMANN, FISHER, & HEINKE CO., L.P.A., 1100 Superior Ave., Ste. 1750, Cleveland, OH, 44114, US

(21) Appl. No.: 10/419,541

(22) Filed: Apr. 21, 2003

Related U.S. Application Data
(63) Continuation-in-part of application No. 09/998,697, filed on Nov. 30, 2001, now Pat. No. 6,550,775.
Application No. 09/998,697 is a continuation-in-part of application No. 09/726,814, filed on Nov. 30, 2000, now Pat. No. 6,367,802.

(51) Int. Cl. F16L 33/16

(52) U.S. Cl. 277/314

(57) ABSTRACT

A permanently lubricated annular gasket for providing a fluid-tight seal between a corrugated pipe and a smooth annular section of an outer pipe or section when the corrugated pipe and the outer pipe or section are in a relative surrounded and surrounding relationship. A first portion of the gasket is shaped to fit within a groove or recess of the corrugated pipe. A second portion of the gasket extends from the first portion. The second portion is at least partially comprised of permanently lubricated thermoplastic material. The second portion is configured to make sealing contact with the outer pipe or section when the corrugated pipe and the outer pipe or section are in a relative surrounded and surrounding relationship.

### RELATE BACK

The present application is a continuation in part application containing common subject matter as previously filed and co-pending application Ser. No. 09/998,697, filed in the U.S. Patent and Trademark Office on Nov. 30, 2001, to issue as U.S. Pat. No. 6,550,775, entitled “ANNULAR GASKET,” which is a continuation-in-part of U.S. patent application Ser. No. 09/726,814, entitled “ANNULAR GASKET WITH LOCKING STRUCTURE,” now U.S. Pat. No. 6,367,802, which are incorporated by reference in their entirety.

### TECHNICAL FIELD

The present invention relates to elastomeric gaskets and, more specifically, to a gasket, at least a portion of which is made from a thermoplastic combined with a lubricating chemical that permanently imparts properties of a lubricant on the gasket for providing a seal between a pair of tubular members.

### BACKGROUND ART

It is well known to form a seal between two pipe sections, such as two corrugated pipe sections, where the end of one of the pipe sections has annular grooves and one of the pipe sections has an enlarged bell portion at one end. Some prior art elastomeric gaskets are placed around the end of the pipe section having annular grooves. The pipe section having annular grooves is inserted into an enlarged bell portion of a second pipe section. The elastomeric gasket contacts each of the pipe sections to form a seal between the pipe sections.

Typically, a large frictional force is encountered when the inner pipe and the elastomeric gasket is inserted into the outer pipe. As one end of the inner pipe is pushed into the enlarged end or bell of the outer pipe section or pipe connector, the gasket is sometimes pulled from the groove by the large frictional force. When the pipe is not properly sealed, ground water may leak into the pipe or fluid may leak out of the pipe and contaminate the ground.

Lubricant has been manually applied to elastomeric gaskets before the inner pipe and the gasket is inserted into the outer pipe. The lubricant reduces the frictional force between the gasket and the outer pipe. The reduced frictional force reduces the likelihood that the gasket will be pulled from the groove by the frictional force. The manual application of the lubricant is labor intensive. In addition, the manually applied lubricant is wiped from the gasket if the pipe joint is disassembled. As a result, the lubricant must be reapplied before the pipe joint is reassembled.

Prior art methods have been developed that self lubricate gaskets as they are assembled. For example, U.S. Pat. No. 4,365,318 to Tolliver discloses a seal including a cavity containing a lubricant which is released when one pipe joint is slid over the seal. U.S. Pat. No. 5,143,381 to Temple is directed to a seal which has an internal chamber containing a lubricant. A slit in the body of the seal extends into the chamber. When one pipe is moved over another pipe end, the slit is spread, thereby releasing the lubricant against the sealing surface. U.S. Pat. No. 5,626,349 to Sutherland et al. concerns a sealing ring containing a lubricant enclosed within a membrane formed on the ring's body. When a connecting pipe is slid into the pipe joint, the membrane is ruptured, releasing the lubricant and reducing the frictional forces imparted on the sealing ring during the joining of the pipes. U.S. Pat. No. 5,735,528 to Olsson discloses a seal containing a lubricant. The lubricant migrates to the surface of the seal, thereby providing self-lubricating properties. Each of these methods provide the lubricant only the first time, or a limited number of times, the gasket forms a seal. The lubricant is eventually wiped off or spent. After the lubricant is wiped off or spent, a lubricant may need to be manually applied to ensure a proper seal

There is a need for a gasket which is permanently lubricated such that the lubricant remains with the gasket and provides lubrication regardless of the number of times the joint is assembled and disassembled.

### SUMMARY OF THE INVENTION

The present invention concerns a permanently lubricated annular gasket for providing a fluid-tight seal between an inner pipe and a smooth annular section of an outer pipe or section when the corrugated pipe and the outer pipe or section are in a relative surrounded and surrounding relationship. A first portion of the gasket is shaped to fit within a groove or recess of the corrugated pipe. A second portion of the gasket extends from the first portion. The second portion is at least partially comprised of permanently lubricated thermoplastic material. The second portion is configured to make sealing contact with the outer pipe or section when the corrugated pipe and the outer pipe or section are in a relative surrounded and surrounding relationship.

In one embodiment, the first portion and said second portion are co-extruded. In this embodiment, the first portion has a first durometer and the second portion has a second durometer that is less than the first durometer. In this embodiment, the second portion may include a non-lubricated portion and a permanently lubricated portion. In this embodiment, the gasket may be tri-extruded such that the permanently lubricated portion covers the entire non-lubricated portion or such that the lubricated portion covers only the leading edge of the non-lubricated portion. In the alternative, the second portion may be made entirely of permanently lubricated material, while the first portion is made of a non-lubricated material. In another embodiment, both the first portion and the second portion are made from a permanently lubricated thermoplastic material, i.e., the whole gasket is made from the permanently lubricated material.

One aspect of the invention concerns a chemical composition for making the permanently lubricated gasket. The chemical composition includes a silicone dispersion combined with a thermoplastic resin. In the exemplary embodiment of the invention, the silicone dispersion contains a siloxane polymer dispersed in an organic resin. The organic resin may include but is not limited to polyxymethylene, polypropylene, low-density polypropylene and styrene-acrylnitrile. The dispersion preferably has a siloxane content of about 50%. The dispersion is then mixed with a thermoplastic resin. Preferably, the thermoplastic resin contains a block copolymer. The block copolymer may include but is not limited to styrene-ethylene-butylene-styrene, styrene-ethylene-propylene-styrene, polypropylene, ethylene-propylene, and ethylene-propylene-diene monomer copolymers. In one embodiment, the dispersion is present in the composition in a range from of about 2 to about 10% and the thermoplastic resin is present in a range from of about 90 to about 98%. Preferably, the dispersion is present at about 6% and the thermoplastic resin is present at about 94%.

In another embodiment, the thermoplastic resin includes a styrene-butadiene block copolymer. In yet another embodiment, the thermoplastic resin is made up of a block copolymer, pigment, polypropylene, calcium carbonate, antioxident/stablilizer, mineral oil, ethyl vinyl acetate and polyphenylene oxide. In yet another embodiment, the thermoplastic resin includes block copolymer, mineral oil, colorant, polypropylene, calcium carbonate and anitioxident/stabilizer.

The present invention also concerns a hardened thermoplastic composition for use as a gasket. The composition includes a silicone dispersion having a siloxane polymer dispersed in an organic resin and a thermoplastic resin including a block copolymer. In another embodiment, the hardened thermoplastic composition includes a dispersion with a siloxane content of about 50%. In yet another embodiment, the organic resin includes polypropylene. In yet another embodiment, the block copolymer is styrene-ethylene-butylene-styrene.

### BRIEF DESCRIPTION OF THE DRAWINGS

FIG. 1 is a perspective view of a portion of the annular gasket of one embodiment of the present invention;

FIG. 2 is a cross section of the elastomeric gasket of one embodiment of the present invention;

FIG. 3 is a sectional view of a gasket of the present invention installed on a corrugated pipe;

FIG. 4 is a sectional view of a gasket of the present invention installed on a corrugated pipe, and engaged by an enlarged end of a second pipe;

FIG. 5 is an enlarged fragmented view of FIG. 3;

FIG. 6 is an enlarged fragmented view of FIG. 4;

FIG. 7A is a sectional view of the elastomeric gasket of one embodiment of the present invention;

FIG. 7B is a sectional view of the elastomeric gasket of one embodiment of the present invention;

FIG. 8 is a sectional view of the elastomeric gasket of one embodiment of the present invention; and

FIG. 9 is a sectional view of the elastomeric gasket of one embodiment of the present invention.

### DETAILED DESCRIPTION OF THE PREFERRED EMBODIMENTS

The present invention is directed to a permanently lubricated annular gasket 10 for providing a fluid tight seal between a first tubular member 12 and second tubular member 18. In the illustrated embodiment, the first tubular member has a plurality of annular grooves 14 and ridges 16 and the second tubular member includes a smooth annular section 20, such as a bell. At least a portion of the gasket is made from an elastomeric material having properties of a lubricated material (i.e. reduced coefficient of friction). This portion is made from a thermoplastic that permanently contains lubricating chemicals that impart characteristics of a lubricant on the thermoplastic. In the exemplary embodiment, the lubricating chemical does not migrate out of the thermoplastic when pressure is applied to sealing portion. This allows the gasket to provide a “Lubeless Joint,” that is, the gasket does not have to be manually lubricated with any type of chemical or organic pipe lubricant before assembly. Water may be applied to ease assembly.

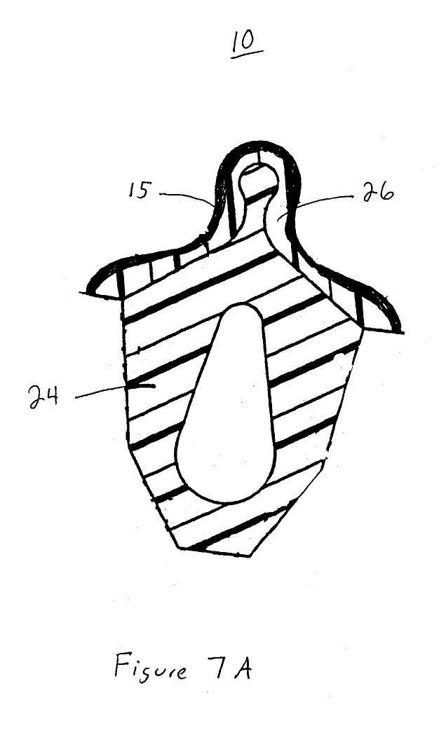

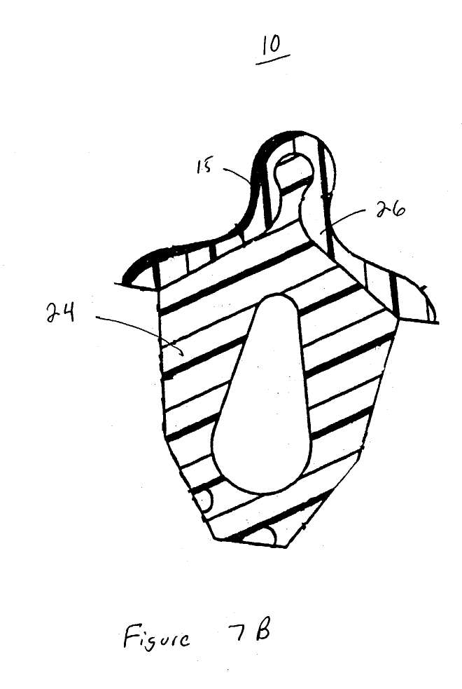

The Figures illustrate one example of a physical configuration of a permanently lubricated gasket. However, the inventive permanently lubricated gasket 10 could take any physical form without departing from the spirit and scope of the claimed invention. Referring to FIGS. 4 and 6, the illustrated permanently lubricated annular gasket 10 seals a gap 21 between the first tubular member 12 and the smooth annular section 20 of the second member 18 when the first tubular member and the smooth section are in a relative surrounded and surrounding relationship. In the illustrated embodiment, the second tubular member 18 is a corrugated pipe having an integral bell or large end that is not corrugated. In an alternate embodiment, the integral bell or large end includes corrugations that strengthen the integral bell or large end. In the illustrated embodiment, the first tubular member 12 is a corrugated pipe that includes a recess 22 in one of the ridges 16. It should be readily apparent that the inventive permanently lubricated gasket gasket could be used on any type of pipe. For example, the permanently lubricated gasket could be used with PVC pipe, corrugated metal pipe, corrugated plastic pipe, fiberglass pipe, or cast iron pipe. Further, it should be readily apparent that the outer pipe could include corrugation(s) while the end of the inner pipe is smooth. For example, the permanently lubricated gasket could be used to form a PVC bell and spigot joint.

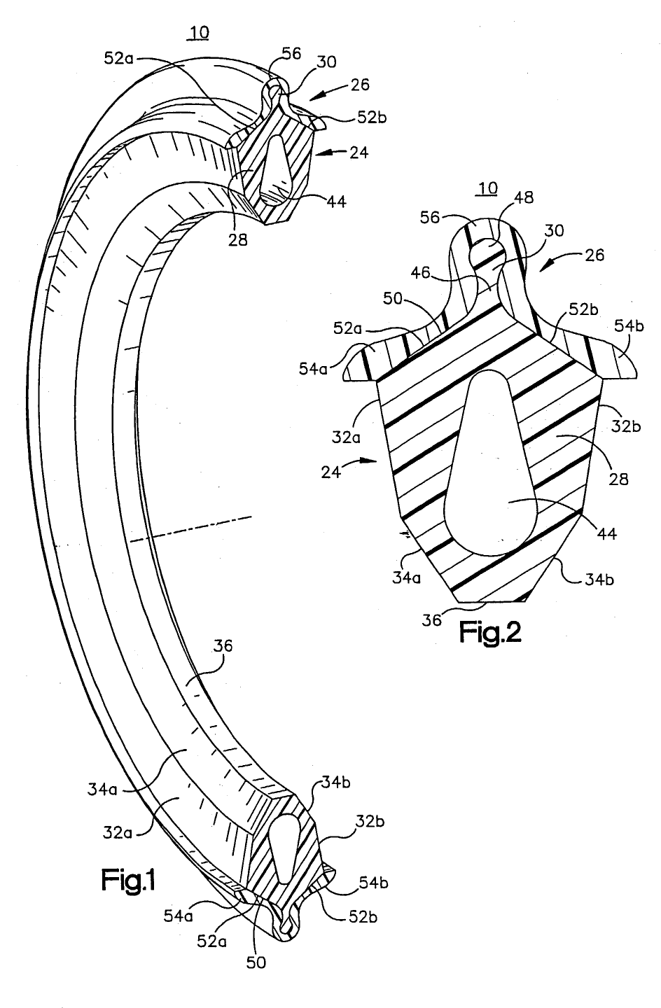

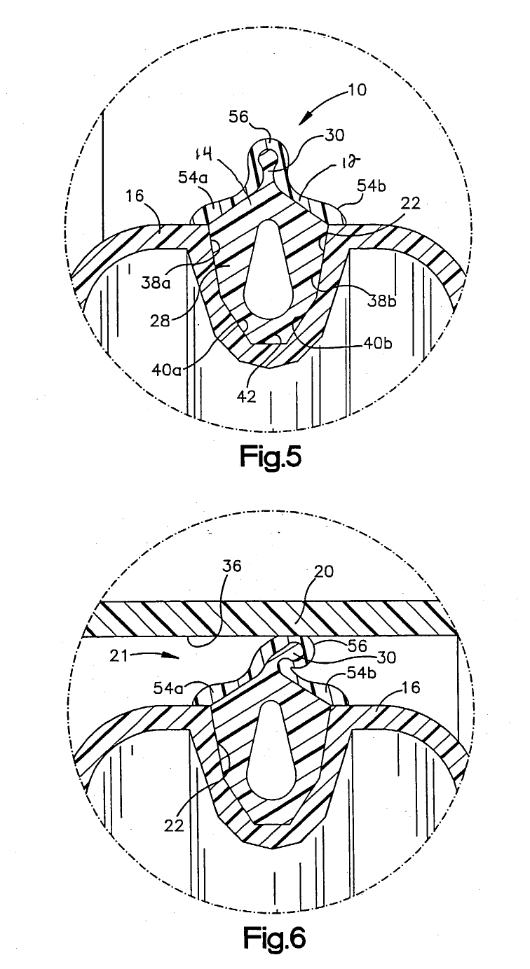

Referring to FIGS. 1 and 2, the annular gasket 10 includes a first, support portion 24 and a second, elastomeric gasket portion 26. The support portion 24 is made from a material having a first, relatively hard, durometer. In the illustrated embodiment, the support portion 24 includes an anchor portion 28 shaped to fit within the recess 22 in a ridge 16 of the corrugated pipe and a tip portion 30 that extends radially outward from the anchor portion 28. In an alternate embodiment, (not illustrated) the anchor portion 28 is shaped to fit within a groove 14 in the corrugated pipe. Referring to FIG. 5, the tip portion 30 is radially outward of the ridge 16 when the anchor portion 28 is disposed in the recess 22 in the ridge 16 or a groove 14 in the corrugated pipe.

The anchor portion 28 is shaped to fit within the recess 22 in a ridge 16 in the corrugated pipe. The shape of the anchor portion 28 can be changed to fit within recesses having different shapes or to fit within a groove 14 in the corrugated pipe. Referring to FIGS. 1 and 2, the illustrated support portion 28 includes first and second side surfaces 32a, 32b, first and second intermediate surfaces 34a, 34b, and an inner surface 36. Referring to FIG. 5, the first and second side surfaces 32a, 32b correspond to first and second side walls 38a, 38b of the recess 22. The intermediate surfaces 34a, 34b correspond to intermediate walls 40a, 40b. The inner surfaces 36 corresponds to a bottom wall 42 of the recess 22. The anchor portion 28 includes an outer surface 50 formed by first and second radially outer lateral surfaces 52a, 52b.

Referring to FIGS. 1 and 2, the anchor portion 28 includes an opening 44. The opening 44 reduces the amount of material needed to form the anchor portion 28. In the illustrated embodiment, the opening 42 has a tear drop shape. It should be readily apparent to those skilled in the art that any shape of opening could be used.

Referring to FIGS. 1 and 2, the illustrated tip portion 30 includes a transition portion 46 or neck portion and an end portion 48 that is rounded in the illustrated embodiment. The transition portion 46 is an area of reduced thickness that extends from the outer surface 50 of the anchor portion 28 in the illustrated embodiment. It should be readily apparent to those skilled in the art that the thickness of the transition portion 46 can be varied to increase or decrease an amount of force required to deflect the end portion 48. The end portion 48 extends radially outward from the neck portion 46. It should also be readily apparent to those skilled in the art that the end portion can be any shape that holds a gasket portion in contact with the second tubular member.

In the exemplary embodiment, a harder SEBS material is used to construct the support portion 24. Use of a harder material for constructing the support portion 24 increases the force required to fold the tip portion 30 over. The result is that a tighter seal is provided against the smooth annular section 20 and the ridge 16. The SEBS material reinforces the pipe corrugation, reducing the amount deflection when pressure is applied. It should be readily apparent that other filler material can be used to construct the support portion 24 of the gasket 10. The SEBS material could be replaced with any type of harder material. SEBS material is relatively inexpensive and has good elasticity. It should also be readily apparent that the support portion can be made from the same material that the gasket portion 26 to eliminate the co-extrusion process.

The elastomeric gasket portion 26 is made from a second material having a durometer that is less than the durometer of the support portion 24. Referring to FIGS. 1 and 2, the gasket portion 26 is disposed on the tip portion 30 and the outer surface 50 of the support portion 24. The gasket portion 26 is configured to make sealing contact with a ridge 16 and the smooth annular section 20 when a corrugated pipe having a recess 22 in which the gasket 10 is received and the smooth annular section 20 of the second tubular member 18 are in a relative surrounding relationship (see FIGS. 4 and 6).

The illustrated elastomeric gasket portion 26 includes first and second leg portions 54a, 54b connected by a central portion 56. The central portion 56 covers the tip portion 30 of the support portion 24. The central portion 56 can be configured in any shape that makes contact with the smooth annular section 20. The first and second leg portions 54a, 54b cover the radially outer surfaces 52a, 52b of the anchor portion 28 and extend laterally of the first and second side surfaces 32a, 32b of the anchor portion 28. In the exemplary embodiment, the gasket portion 26 and the support portion 24 are co-extruded. In another embodiment, the support portion and the gasket portion are bonded together by some means other than co-extrusion. The gasket may be attached to the support portion by adhesives or any other acceptable attachment method.

The gasket 10 can be made by extruding a length of gasket material and connecting its ends together by gluing or vulcanization. For example, an annular gasket 20 for an 18 inch pipe would be formed of a 57.5 inch of gasket material. An annular gasket 20 for a 24 inch pipe would be formed from a 76.0 inch length of gasket material. The annular gasket 20 can also be molded to eliminate the step of connecting the gasket ends.

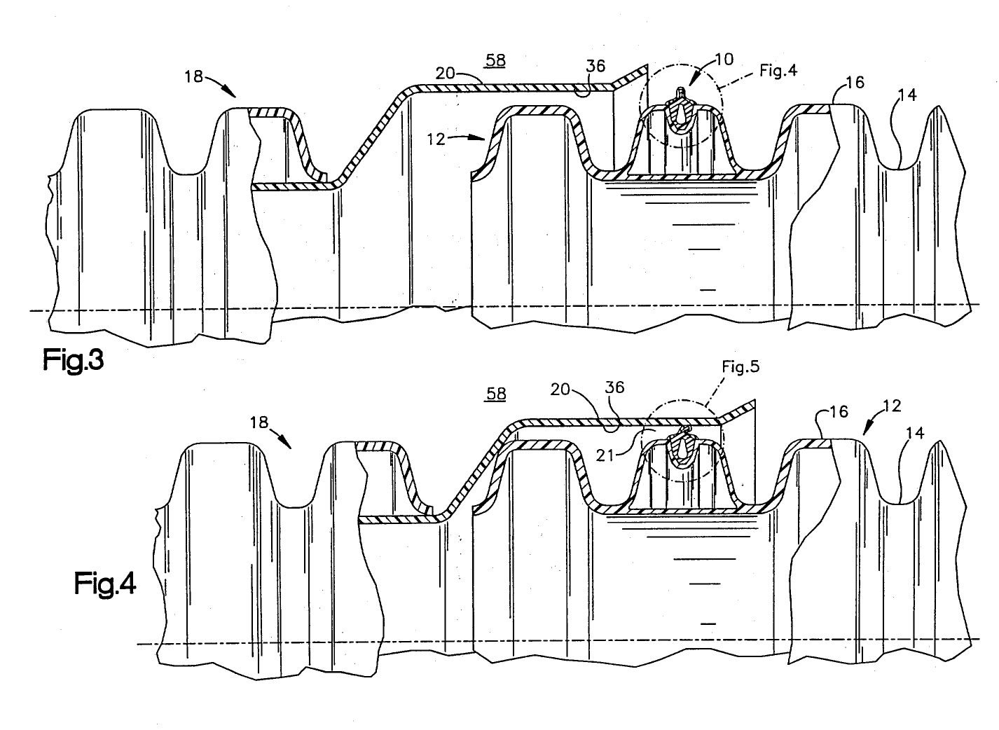

FIGS. 3, and 4 illustrate a coupling 58 formed with the disclosed gasket 10. Although the gasket 10 could be used to form a joint between metal, concrete and other tubular sections, it is particularly well suited for use with corrugated plastic pipe. The illustrated coupling 58 includes a corrugated pipe 12, an outer annular section 20 (a bell portion of a second corrugated pipe in the illustrated embodiment) and an annular gasket 10. The corrugated pipe 12 has annular grooves 14 in ridges 16. In the illustrated embodiment, one of the ridges 16 includes a recess 22 that receives an anchor portion 28 of the gasket 10. In an alternate embodiment, the anchor portion 28 is sized to fit within one of the grooves 14 in the corrugated pipe. The annular section 20 is disposed around the corrugated pipe 12. The annular gasket 10 is disposed between the corrugated pipe 12 and the annular section 20. The anchor portion 28 of the annular gasket 10 is disposed within the recess 22. The tip portion 30 of the support portion 24 extends radially outward of the ridge 16. Referring to FIG. 6, the first and second leg portions 54a, 54b are disposed on a ridge 16 and make sealing contact with a ridge 16. The central portion 56 of the gasket portion 26 makes sealing contact with the smooth annular section 20.

Referring to FIG. 6, the smooth annular section 20 or enlarged bell portion applies pressure to the central portion 56 of the gasket portion 10 and deforms the central portion 56. The tip portion 30 is harder than the gasket material, increasing the force required to fold over or bend the central portion 56 of the gasket 10. The increase in force required to deform the central portion 56 results in a tighter seal between the central portion 56 and the bell of the second tubular member and a tighter seal between the leg portions 54a, 54b and the ridge 16.

In addition, since the material of the anchor portion 28 is harder than the gasket portion 26 material, the anchor portion 28 material reinforces the pipe corrugation, reducing the amount of deflection of the pipe corrugation when pressure is applied. Referring to FIGS. 3, 4, 5 and 6, the disclosed gasket 10 is used in a method of providing a fluid tight seal between a corrugated pipe having a ridge 16 that includes a recess 22 and a smooth inner surface 36 of an annular section 20 or bell portion. The support portion 24 of the gasket 10 is inserted into the recess 22 of a corrugated pipe. The tip portion 30 of the support portion 24 extends radially outward of the ridge 16. The ridge 16 is engaged with the leg portions 54a, 54b that are disposed on the radially outer surfaces 52a, 52b of the support portion 24. The corrugated pipe is inserted into a smooth annular section 20, such as the depicted bell portion of a corrugated pipe having a smooth inner surface 60. The smooth annular section 20, or bell portion, is engaged with the central portion 56 of the elastomeric gasket portion 26. The central portion 56 of the elastomeric gasket portion 26 and the tip portion 30 of the support portion 24 are deformed by the smooth annular section 20, or bell. The harder tip portion 30 resists deformation and presses the central portion 56 and gasket portion 26 tightly against the bell, thereby creating a tight seal between the central portion 56 in the bell. The increase in force required to deform the tip portion 30 presses leg portions tightly against the ridge 16.

Referring to FIG. 5, in a first embodiment, the first, support portion 24 is made from a material that is not permanently lubricated having a first, relatively hard, durometer. For example, the support portion may be made from a material having a 70 durometer hardness. In this embodiment, the second gasket portion 26 is made from the elastomeric material containing the lubricating chemical, making the entire gasket portion 26 permanently lubricated.

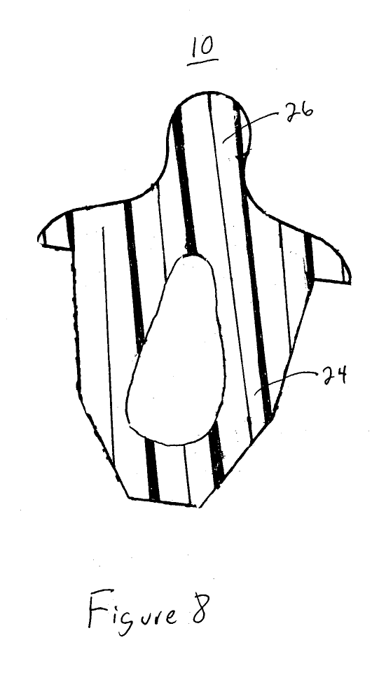

Referring to FIGS. 7A and 7B, in a second embodiment, the permanently lubricated annular gasket 10 is formed by tri-extruding the support portion 24, an elastomeric portion 26, and a lubricated material portion 15 on the elastomeric portion. The support portion 24 is made from a material having a first, relatively hard, durometer. In this embodiment, the gasket portion 26 is made from a conventional elastomeric material that does not include the lubricating chemical. For example, the gasket portion 26 may be made from natural or synthetic rubbers, such as Isoprene or Ethylene Propylene Diene Monumer (EPDM). The elastomeric portion may be 50 duromoter elastomeric material. The lubricated material portion 15 of the gasket portion 12 is made from the elastomeric material containing the lubricating chemical, making it permanently lubricated. In the embodiment illustrated by FIG. 7A, the lubricating material portion 15 covers the entire elastomeric portion. In the embodiment illustrated by FIG. 7B, the lubricating material portion 15 covers only the leading edge of the gasket. This is the area that comes in contact with a coupler pipe first.

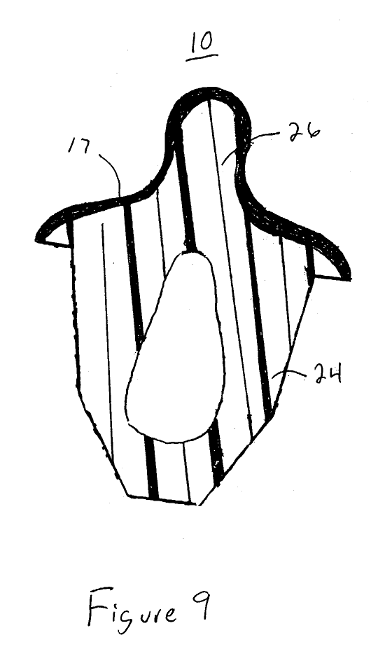

Referring to FIG. 8, in one embodiment, the gasket is made entirely of a single permanently lubricated elastomeric material. In this embodiment, the entire gasket can be made from the elastomeric material containing the lubricating chemical. In an embodiment illustrated by FIG. 9, the gasket is made from a conventional elastomeric material with a covering layer 17 or a partial covering layer (not shown, but see FIG. 7B) of elastomeric material containing the lubricating chemical.

The second or gasket portion 26 of the gasket is at least partially made from a material having properties of a lubricated material (i.e. reduced coefficient of friction). In the exemplary embodiment, the elastormeric sealing portion 26 is made from a thermoplastic that contains a lubricating composition that provides lubrication to the elastomeric sealing portion. This allows the gasket to have a “Tubeless joint,” that is, the gasket does not have to be manually lubricated with any type of chemical or organic pipe lubricant before assembly and throughout the life of the gasket.

The lubricating chemical is combined with a thermoplastic resin before the gasket is extruded. The resulting elastormeric sealing portion thus becomes permanently lubricated. That is, the lubricating chemical does not migrate out of the thermoplastic when pressure is applied to the sealing portion.

The exemplary thermoplastic composition used to extrude a gasket having permanently lubricated properties is comprised of an silicone dispersion combined with a thermoplastic resin. The silicone dispersion contains an siloxane polymer dispersed in a polypropylene homopolymer. The dispersion typically posses a siloxane content of about 50%.

Dispersions for use as an additive for an elastomeric gasket can possess different siloxane contents and employ different organic resins. Organic resins may include, for example, polypropylene, low density polypropylene, styrene-acrylnitrile. The dispersions for use with the present invention can be purchased from Dow Corning® sold under their Masterbatch line of products. Specifically, Dow Corning MB50-001 Masterbatch may be used as the primary additive.

Turning now to the thermoplastic resin, any thermoplastic resin suitable for use in gasket manufacturing may be employed for use in the practice of the invention and as apparent to those of ordinary skill in the art in view of this disclosure. The thermoplastic resin used in accordance with the exemplary embodiment is one containing a block copolymer. Block copolymers include but are not limited to styrene-ethylene-butylene-styrene, styrene-ethylene-propylene-styrene, polypropylene, ethylene-propylene, styrene-butadiene and ethylene-propylene-diene monomer copolymers. Other block copolymers may be employed as apparent to those of ordinary skill in the art. Examples of thermoplastic elastomers for use in the present invention are sold by Multibase, Inc. (a Dow-Corning Company) under the name Multi-Flex. Specifically, Multi-Flex A 5001 E LC and Multi-Flex A 6421.

The Multi-Flex A 5001 E LC's composition is shown in Table I.

TABLE I

| | |
|---|---|
| Component | Range (% by weight) |

| | | |
|---|---|---|
| Block Copolymer | Up to | 28 |
| Pigment | Up to | 2.0 |
| Polypropylene | Up to | 8.0 |
| Calcium Carbonate | Up to | 20 |
| Antioxidant/Stabilizer | Up to | 1.0 |
| Mineral Oil | Up to | 37 |
| Ethyl Vinyl Acetate | Up to | 5.0 |
| Polyphenylene Oxide | Up to | 10 |

The Multi-Flex A 6421's composition is shown in Table II.

TABLE II

| | |
|---|---|
| Component | Range (% by weight) |

| | | |
|---|---|---|
| Block Copolymer (Styrene- | Up to | 60 |
| ethylene-butylene- | | |
| styrene)/Mineral Oil | | |
| Colorant | Up to | 2.0 |
| Polypropylene | Up to | 10 |
| Calcium Carbonate | Up to | 40 |
| Antioxident/stabilizer | Up to | 1.0 |

As discussed, the dispersion is combined with the thermoplastic prior to extruding the gasket. The components may be combined together in a range from of about 2 to about 10% dispersion combined with about 90 to about 98% thermoplastic. More preferably, the components are combined in a range from about 4 to about 8% dispersion and about 92 to about 96% thermoplastic. Yet even more preferable, the components are combined to form a mixture prior to extruding containing about 6% dispersion and about 94% thermoplastic.

U.S. Pat. No. 5,708,084 Hauenstein et al concerns polyolefin compositions that can be extruded at high rates to produce extrudate having improved hydrophobicity. The composition contains a thermoplastic resin and an interactive diorganopolysiloxane process aid. The diorganopolysiloxane having an average molecular weight of at least 10,000. The '084 patent is hereby incorporated by reference in its entirety.

U.S. Pat. No. 5,708,085 to Hauenstein et al. concerns a polyolefin composition that can be extruded at higher temperatures to provide an extrudate having improved hydrophobicity. The composition includes a polyethylene resin and an interactive diorganopolysiloxane process aid having a molecular weight of at least 10,000. Particularly, the diorganopolysiloxane is used in combination with a low-density polyethylene and used as a process aid for linear low-density polyethylene. The '085 patent is hereby incorporated by reference in its entirety.

U.S. Pat. No. 5,789,473 to Hauenstein et al. recites a polyolefin composition that can be extruded at relatively high rates to provide extrudate having a low surface roughness. The composition includes a polyolefin resin and a hydroxy-functional diorganopolysiloxane process aid. The hydroxy functional diorganopolysiloxane is combined with a low-density polyethylene for use as a process aid for linear low-density polyethylene. The '473 patent is hereby incorporated by reference in its entirety.

It will be understood that various modifications can be made without departing from the spirit and scope of the invention.

We claim:

1. A chemical composition for use in the manufacture of a gasket that provides a seal between first and second surfaces, comprising:
a silicone containing dispersion; and,
a thermoplastic resin.

2. The composition of claim 1 wherein said silicone dispersion includes a siloxane polymer dispersed in an organic resin.

3. The composition of claim 2 wherein said organic resin is selected from the group consisting of poloxymethylene, polypropoylene, low-density polypropoylene and styrene-acrylnitrile.

4. The composition of claim 2 wherein said dispersion has a siloxane content of about 50%.

5. The composition of claim 2 wherein said thermoplastic resin includes a block coplymer.

6. The composition of claim 5 wherein said block copolymer is selected from the group consisting styrene-ethylene-butylene-styrene, styrene-ethylene-propylene-styrene, polypropylene, ethylene-propylene, and ethylene-propylene-diene monomer copolymers.

7. The composition of claim 5 wherein said block copolymer is styrene-butadiene.

8. The composition of claim 1 wherein said thermoplastic resin comprises:

| | |
|---|---|
| Component | Range (% by weight) |
| | | |
|---|---|---|
| Block Copolymer | Up to | 28 |
| Pigment | Up to | 2.0 |
| Polypropylene | Up to | 8.0 |
| Calcium Carbonate | Up to | 20 |
| Antioxidant/Stabilizer | Up to | 1.0 |
| Mineral Oil | Up to | 37 |
| Ethyl Vinyl Acetate | Up to | 5.0 |
| Polyphenylene Oxide | Up to | 10 |

9. The composition of claim 1 wherein said thermoplastic resin comprises:

| | |
|---|---|
| Component | Range (% by weight) |
| | | |
|---|---|---|
| Block Copolymer/Mineral Oil | Up to | 60 |
| Colorant | Up to | 2.0 |
| Polypropylene | Up to | 10 |
| Calcium Carbonate | Up to | 40 |
| Antioxident/stabilizer | | 1.0 |

10. The composition of claim 1 wherein said silicone dispersion is present in a range of about 2 to about 10% based on weight.

11. The composition of claim 1 wherein said thermoplastic resin is present in a range of from about 90 to about 98% based on weight.

12. The composition of claim 1 wherein said silicone dispersion is present in a range from of about 2 to about 10% based on weight and said thermoplastic resin is present in a range from of from about 90 to about 98% based on weight.

13. The composition of claim 1 wherein said silicone dispersion is present in an amount of about 6% based on weight and said thermoplastic resin is present in an amount of about 94% based on weight.

14. A chemical composition for use in the manufacture of a gasket that provides a seal between first and second surfaces, comprising:
a silicone containing dispersion in a range from of about 2 to about 10% based on weight; and,
a thermoplastic resin in a range from of about 90 to about 98% based on weight.

15. A chemical composition for use in the manufacture of a gasket that provides a seal between first and second surfaces, comprising:
a silicone containing dispersion in an amount of about 6% based on weight; and,
a thermoplastic resin in an amount of about 94% based on weight.

16. A chemical composition for use in the manufacture of a gasket that provides a seal between first and second surfaces, comprising:
a silicone dispersion including a siloxane polymer dispersed in an organic resin; and,
a thermoplastic resin including a block copolymer.

17. The composition of claim 16 wherein said silicone dispersion has a siloxane content of about 50%.

18. The composition of claim 16 wherein said organic resin includes polypropylene

19. The composition of claim 16 wherein said block copolymer is styrene-ethylene-butylene-styrene.

20. A chemical composition for use in the manufacture of a gasket that provides a seal between first and second surfaces comprising:
a silicone dispersion including a siloxane polymer dispersed in an organic resin, wherein said dispersion has a siloxane content of about 50% and wherein said organic resin is polypropylene; and,
a thermoplastic resin including a block copolymer wherein said copolymer is styrene-ethylene-butylene-styrene.

21. A hardened thermoplastic composition for use as a gasket that provides a seal between first and second surfaces, comprising:
a silicone dispersion including a siloxane polymer dispersed in an organic resin; and,
a thermoplastic resin including a block copolymer.

22. The composition of claim 21 wherein said silicone dispersion has a siloxane content of about 50%.

23. The composition of claim 21 wherein said organic resin includes polypropylene

24. The composition of claim 21 wherein said block copolymer is styrene-ethylene-butylene-styrene.

25. An annular gasket for providing a fluid-tight seal between a corrugated pipe having an annular groove and an adjacent ridge that includes a recess, and a smooth annular section of a second member, when the corrugated pipe and the section are in a relative surrounded and surrounding relationship, comprising:
a) a first portion shaped to fit within one of the recess in the ridge and the annular groove; and
b) a second portion extending from said first portion, said second portion comprises a permanently lubricated thermoplastic material, said second portion being configured to make sealing contact with the smooth annular section when the corrugated pipe and the smooth annular section are in a relative surrounded and surrounding relationship.

26. The annular gasket of claim 25 wherein said first portion and said second portion are coextruded, said first portion having a first durometer, said second portion having a second durometer that is less than said first durometer.

27. The annular gasket of claim 25 wherein said second portion includes a non-lubricated portion and a permanently lubricated portion.

28. The annular gasket of claim 27 wherein said permanently lubricated portion is disposed radially outward of said non-lubricated portion.

29. The annular gasket of claim 27 wherein said lubricated portion covers a leading edge of said second portion.

30. The annular gasket of claim 25 wherein said permanently lubricated thermoplastic material comprises a silicone containing dispersion and a thermoplastic resin.

31. The annular gasket of claim 30 wherein said silicone containing dispersion includes a siloxane polymer dispersed in an organic resin.

32. The annular gasket of claim 30 wherein said resin is selected from the group consisting of poloxymethylene, polypropoylene, low-density polypropoylene and styrene-acrylnitrile.

33. The annular gasket of claim 30 wherein said dispersion has a siloxane content of about 50%.

34. The annular gasket of claim 30 wherein said thermoplastic resin includes a block coplymer.

35. The annular gasket of claim 34 wherein said block copolymer is selected from the group consisting styrene-ethylene-butylene-styrene, styrene-ethylene-propylene-styrene, polypropylene, ethylene-propylene, and ethylene-propylene-diene monomer copolymers.

36. The annular gasket of claim 34 wherein said block copolymer is styrene-butadiene.

37. The annular gasket of claim 30 wherein said thermoplastic resin comprises:

| | |
|---|---|
| Component | Range (% by weight) |
| | | |
|---|---|---|
| Block Copolymer | Up to | 28 |
| Pigment | Up to | 2.0 |
| Polypropylene | Up to | 8.0 |
| Calcium Carbonate | Up to | 20 |
| Antioxidant/Stabilizer | Up to | 1.0 |
| Mineral Oil | Up to | 37 |
| Ethyl Vinyl Acetate | Up to | 5.0 |
| Polyphenylene Oxide | Up to | 10 |

38. The annular gasket of claim 30 wherein said thermoplastic resin comprises:

| | |
|---|---|
| Component | Range (% by weight) |
| | | |
|---|---|---|
| Block Copolymer/Mineral Oil | Up to | 60 |
| Colorant | Up to | 2.0 |
| Polypropylene | Up to | 10 |
| Calcium Carbonate | Up to | 40 |
| Antioxident/stabilizer | | 1.0 |

39. The annular gasket of claim 30 wherein said silicone dispersion is present in a range of about 2 to about 10% based on weight.

40. The annular gasket of claim 30 wherein said thermoplastic resin is present in a range of from about 90 to about 98% based on weight.

41. The annular gasket of claim 30 wherein said silicone dispersion is present in a range from of about 2 to about 10% based on weight and said thermoplastic resin is present in a range from of from about 90 to about 98% based on weight.

42. The annular gasket of claim 30 wherein said silicone dispersion is present in an amount of about 6% based on weight and said thermoplastic resin is present in an amount of about 94% based on weight.

43. A co-extruded annular gasket for providing a fluid-tight seal between a corrugated pipe having an annular groove and an adjacent ridge that includes a recess, and a smooth annular section of a second member, when the corrugated pipe and the section are in a relative surrounded and surrounding relationship, comprising:
a) a support portion having a first durometer that includes an anchor portion shaped to fit within at least one of the recess in the ridge and the annular groove and a tip portion extending radially outward from said anchor portion, said tip portion is radially outward of the ridge; and
b) a permanently lubricated gasket portion having a second durometer that is less than said first durometer disposed on said tip portion of said support portion, said permanently lubricated gasket portion being configured to make sealing contact with the ridge and the smooth annular section when the corrugated pipe and the smooth annular section are in a relative surrounded and surrounding relationship.

44. The annular gasket of claim 43 wherein said permanently lubricated portion includes a non-lubricated portion and a permanently lubricated portion.

45. The annular gasket of claim 44 wherein said permanently lubricated portion is disposed radially outward of said non-lubricated portion.

46. The annular gasket of claim 44 wherein said lubricated portion covers a leading edge of said second portion.

47. The annular gasket of claim 43 wherein said permanently lubricated gasket portion comprises a silicone containing dispersion and a thermoplastic resin.

48. The annular gasket of claim 47 wherein said silicone containing dispersion includes a siloxane polymer dispersed in an organic resin.

49. The annular gasket of claim 47 wherein said resin is selected from the group consisting of poloxymethylene, polypropoylene, low-density polypropoylene and styrene-acrylnitrile.

50. The annular gasket of claim 47 wherein said dispersion has a siloxane content of about 50%.

51. The annular gasket of claim 47 wherein said thermoplastic resin includes a block coplymer.

52. The annular gasket of claim 51 wherein said block copolymer is selected from the group consisting styrene-ethylene-butylene-styrene, styrene-ethylene-propylene-styrene, polypropylene, ethylene-propylene, and ethylene-propylene-diene monomer copolymers.

53. The annular gasket of claim 51 wherein said block copolymer is styrene-butadiene.

54. The annular gasket of claim 47 wherein said thermoplastic resin comprises:

| | |
|---|---|
| Component | Range (% by weight) |
| | | |
|---|---|---|
| Block Copolymer | Up to | 28 |
| Pigment | Up to | 2.0 |
| Polypropylene | Up to | 8.0 |
| Calcium Carbonate | Up to | 20 |
| Antioxidant/Stabilizer | Up to | 1.0 |
| Mineral Oil | Up to | 37 |
| Ethyl Vinyl Acetate | Up to | 5.0 |
| Polyphenylene Oxide | Up to | 10 |

55. The annular gasket of claim 47 wherein said thermoplastic resin comprises:

| | |
|---|---|
| Component | Range (% by weight) |
| | | |
|---|---|---|
| Block Copolymer/Mineral Oil | Up to | 60 |
| Colorant | Up to | 2.0 |
| Polypropylene | Up to | 10 |
| Calcium Carbonate | Up to | 40 |
| Antioxident/stabilizer | | 1.0 |

56. The annular gasket of claim 47 wherein said silicone dispersion is present in a range of about 2 to about 10% based on weight.

57. The annular gasket of claim 47 wherein said thermoplastic resin is present in a range of from about 90 to about 98% based on weight.

58. The annular gasket of claim 47 wherein said silicone dispersion is present in a range from of about 2 to about 10% based on weight and said thermoplastic resin is present in a range from of from about 90 to about 98% based on weight.

59. The annular gasket of claim 47 wherein said silicone dispersion is present in an amount of about 6% based on weight and said thermoplastic resin is present in an amount of about 94% based on weight.
